(19) United States
(12) Patent Application Publication
(10) Pub. No.: US 2023/0136811 A1
(43) Pub. Date: May 4, 2023

(54) ANTENNA DEVICE, ARRAY OF ANTENNA DEVICES, AND BASE STATION

(71) Applicant: HUAWEI TECHNOLOGIES CO., LTD., Shenzhen (CN)

(72) Inventors: Juan Segador Alvarez, Munich (DE); Dingjiu Daojian, Dongguan (CN)

(21) Appl. No.: 17/986,641

(22) Filed: Nov. 14, 2022

Related U.S. Application Data
(63) Continuation of application No. PCT/EP2020/063396, filed on May 14, 2020.

(51) Int. Cl. H01Q 9/04; H01Q 13/18

(52) U.S. Cl. CPC H01Q 9/045; H01Q 13/18

(57) ABSTRACT

An antenna device includes a first feeding node and a second feeding node, a bottom layer arranged as a cavity-backed ground, and a middle layer arranged above bottom layer. A first feeding line and a third feeding line of middle layer are electrically connected to first feeding node and a second feeding line and a fourth feeding line of middle layer are electrically connected to second feeding node. The antenna device further includes a top layer arranged above middle layer. The top layer has four slots, where a portion of first slot, a portion of second slot, a portion of third slot and a portion of fourth slot overlap with a portion of first feeding line, a portion of second feeding line, a portion of third feeding line and a portion of fourth feeding line, respectively. A radiator arranged above top layer at a distance from top layer.

### CROSS-REFERENCE TO RELATED APPLICATIONS

This application is a continuation of International Application No. PCT/EP2020/063396, filed on May 14, 2020, the disclosure of which is hereby incorporated by reference in its entirety.

### TECHNICAL FIELD

The present disclosure relates generally to the field of telecommunication devices, and more specifically, to an antenna device, an array of antenna devices, and a base station that includes one or more antenna devices.

### BACKGROUND

With the deployment of new wireless communication technologies, such as fifth generation (5G) communication technology, and in order to support new frequency bands (e.g. 700 Megahertz, 3.5 Gigahertz, and the like) there is a growing demand to develop antennas operating in such frequency bands. Despite an increase in the number of required frequency bands as well as an increase in the number of users (i.e. terrestrial mobile users), there is a limitation associated with the number of antennas which can be deployed. Typically, there is a strict requirement of one antenna per sector (in some cases, at most two antennas per sector). Currently, there are limitations associated with a size of a given antenna that can be deployed. For example, in order to facilitate certain activities related to telecommunication services, such as site acquisition and/or reuse of current mechanical support structures at the sites, it is expected that the form factor and the wind-load of any new antennas that are to be deployed should be similar and comparable to legacy products.

In certain scenarios, neither network densification (i.e. addition of new sites), may be allowed nor installation of any additional conventional antennas at the installation sites. Moreover, a significant increase in the size (i.e. dimensions) of the conventional antenna is also not preferred or allowed. Thus, in such scenarios, it becomes technically challenging to design and develop an adequate antenna structure without increasing complexity. Currently certain attempts have been made to design and develop an antenna device which may integrate one or more radiators and operate in one or more frequency bands together per antenna. However, conventional antenna devices have a technical problem of high structural complexity, which also increases the complexity in manufacturing of such conventional antenna devices. In an example, a conventional antenna device may have two radiators (e.g. dual-band radiators) integrated into one conventional antenna device. However, such conventional antenna device needs several probes (e.g. four or more probes) to feed current to the radiators. Such probes may be required to be soldered to a printed circuit board (PCB) and the radiators in order to mechanically hold the radiators, thereby increasing the number of parts and the complexity of the conventional antenna device or a conventional antenna that uses such conventional antenna devices. In another example, some conventional antenna device employs several coaxial cables (e.g. four or more different cables) to feed current to the different radiators of the conventional antenna device, thereby significantly increasing the complexity.

In yet another example, a conventional antenna device may have a high frequency band radiator embedded inside a low frequency band radiator. However, such an arrangement of the radiators impacts the performance of conventional antenna device as there is a considerable amount of interference between signals of low frequency band and signals of high frequency band. In another example, a conventional antenna device may employ a continuous slot (e.g. a circular or a square-shaped continuous ring slot), which increases the difficultly in routing out the signals of a high band radiator embedded in a low band radiator in an antenna device, which is not desirable.

Therefore, in light of the foregoing discussion, there exists a need to overcome the aforementioned drawbacks associated with conventional antenna devices.

### SUMMARY

The present disclosure seeks to provide an antenna device, an array of antenna devices, and a base station that includes one or more antenna devices. The present disclosure seeks to provide a solution to the existing problem of structural complexity as well as manufacturing complexity associated with conventional antenna devices. An aim of the present disclosure is to provide a solution that overcomes at least partially the problems encountered in prior art and provide an improved antenna device that is compact and have low structural and manufacturing complexity as compared to a conventional antenna device.

The object of the present disclosure is achieved by the solutions provided in the enclosed independent claims. Advantageous implementations of the present disclosure are further defined in the dependent claims.

In a first aspect, the present disclosure provides an antenna device. The antenna device comprises a first feeding node and a second feeding node. The antenna device further comprises a bottom layer arranged as a cavity-backed ground. The antenna device further comprises a middle layer arranged above the bottom layer, the middle layer comprising a first feeding line, a second feeding line, a third feeding line and a fourth feeding line. The first feeding line and the third feeding line are electrically connected to the first feeding node, and the second feeding line and the fourth feeding line are electrically connected to the second feeding node. The antenna device further comprises a top layer arranged above the middle layer, the top layer having a first slot, a second slot, a third slot and a fourth slot formed in the top layer. A portion of the first slot, a portion of the second slot, a portion of the third slot and a portion of the fourth slot overlap with a portion of the first feeding line, a portion of the second feeding line, a portion of the third feeding line and a portion of the fourth feeding line, respectively. The antenna device further comprises a radiator arranged above the top layer at a distance from the top layer.

The antenna device of the first aspect is compact in size and has lower complexity (i.e. the structural and manufacturing complexity is significantly lower) as compared to a conventional antenna device. The antenna device does not use any additional parts, such as probes or cables, to connect the feeding lines to the slots, thereby reducing the complexity of the antenna device. The four slots (i.e. the first slot, the second slot, the third slot, the fourth slot) of the antenna device are non-continuous, and does not employ any additional structures to prevent unnecessary electrical intersections, thereby simplifying the design of the antenna device.

In a first implementation form of the first aspect, the radiator is a first radiator and the distance is a first distance and the antenna device further comprises a second radiator arranged above the first radiator at a second distance from the top layer.

As the second radiator is arranged above the first radiator at the second distance from the top layer, an ultra-compact dual-band antenna device is provided without degradation of performance of the antenna device.

In a second implementation form of the first aspect, the first radiator is configured to radiate a first electromagnetic signal in a first frequency band and the second radiator is configured to radiate a second electromagnetic signal in a second frequency band.

The arrangement of the first radiator and the second radiator in the antenna device enables the antenna device to radiate electromagnetic signals in two different frequency bands with almost no interference or at least reduced interference between the radiated electromagnetic signals.

In a third implementation form of the first aspect, the first radiator is a patch radiator.

By virtue of using the patch radiator, the antenna device is simplified, and the overall size and complexity of the antenna device is reduced.

In a fourth implementation form of the first aspect, the first radiator has a planar structure with an opening at a substantially central position of the first radiator, and where the second radiator lies above the opening.

The opening at the substantially central position of the first radiator simplifies the arrangement of the second radiator above the first radiator, thereby increasing the compactness of the antenna device without degradation of performance of the antenna device. Moreover, the central area of the top layer is free of any features (e.g. slots) and the opening lie above the central area. Thus, the opening enables to provide support as well as feed current to the second radiator without increasing any parts in the antenna device and without causing any signal interference when the first radiator and the second radiator are in operation.

In a fifth implementation form of the first aspect, the antenna device comprises a multilayer printed circuit board, and where the top layer, the middle layer and the bottom layer are layers of the multilayer printed circuit board.

By use of the multilayer printed circuit board, a compact and a light weight antenna device is obtained.

In a sixth implementation form of the first aspect, the antenna device comprises a dual layer printed circuit board, where a first layer of the dual layer printed circuit board is the top layer and a second layer of the dual layer printed circuit board is the middle layer and the bottom layer is implemented in a separate part capacitively or galvanically coupled to the middle layer.

In a seventh implementation form of the first aspect, each of the slots has a meandering shape.

The four slots are arranged in such a way that a central area of the top layer is vacant (i.e. free of any features, such as any slots, connections, and the like). This provides a capability to the antenna device to accommodate one or more radiators above the top layer without interfering.

In an eight implementation form of the first aspect, the antenna device further comprises four standoffs arranged between the first radiator and the top layer, wherein the four standoffs are electrically non-conductive.

The four standoffs provide adequate support to position the first radiator above the top layer at the first distance.

In a second aspect, the present disclosure provides an array of antenna devices, the array comprising one or more antenna devices of the first aspect.

The array of antenna devices of the second aspect achieves all the advantages and effects of the first aspect.

In a third aspect, the present disclosure provides a base station comprising one or more antenna devices according to the first aspect.

The base station that includes the one or more antenna devices of the third aspect achieves all the advantages and effects of the first aspect.

It has to be noted that all devices, elements, circuitry, units and means described in the present application could be implemented in the software or hardware elements or any kind of combination thereof. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in respective software or hardware elements, or any kind of combination thereof. It will be appreciated that features of the present disclosure are susceptible to being combined in various combinations without departing from the scope of the present disclosure as defined by the appended claims.

Additional aspects, advantages, features and objects of the present disclosure would be made apparent from the drawings and the detailed description of the illustrative implementations construed in conjunction with the appended claims that follow.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1A is a perspective view of an antenna device, in accordance with an embodiment of the present disclosure;

FIG. 1B is an illustration of a top layer arranged above a middle layer in an antenna device, in accordance with an embodiment of the present disclosure;

FIG. 1C is an illustration of an exemplary top layer in an antenna device, in accordance with an embodiment of the present disclosure;

FIG. 1D is an illustration of an exemplary middle layer in an antenna device, in accordance with an embodiment of the present disclosure;

FIG. 1E is an illustration of an exemplary bottom layer in an antenna device, in accordance with an embodiment of the present disclosure;

FIG. 1F is an illustration of an exemplary standoff of an antenna device, in accordance with an embodiment of the present disclosure;

FIG. 2A is a perspective top view of an antenna device, in accordance with another embodiment of the present disclosure;

FIG. 2B is a perspective bottom view of an antenna device, in accordance with another embodiment of the present disclosure;

FIG. 3A is a perspective top view of an array of antenna devices, in accordance with another embodiment of the present disclosure;

FIG. 3B is a top view of a cavity-backed ground implemented as a separate part, in accordance with an embodiment of the present disclosure;

FIG. 3C is a bottom view of the cavity-backed ground of FIG. 3B integrated with an array of antenna devices, in accordance with an embodiment of the present disclosure;

FIG. 4 is a perspective top view of an antenna device, in accordance with yet another embodiment of the present disclosure;

FIG. 5 is a cross-sectional view of an antenna device, in accordance with another embodiment of the present disclosure;

FIG. 6A is a graphical representation that depicts a radiation pattern of an electromagnetic signal radiated by a first radiator in a first frequency band, in accordance with an embodiment of the present disclosure;

FIG. 6B is a graphical representation that depicts a radiation pattern of an electromagnetic signal radiated by a second radiator in a second frequency band, in accordance with an embodiment of the present disclosure;

FIG. 6C is a graphical representation that depicts a radiation pattern of two electromagnetic signals in two different frequency bands radiated by an antenna device, in accordance with another embodiment of the present disclosure; and

FIG. 7 is a block diagram that illustrates a base station with one or more antenna devices, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

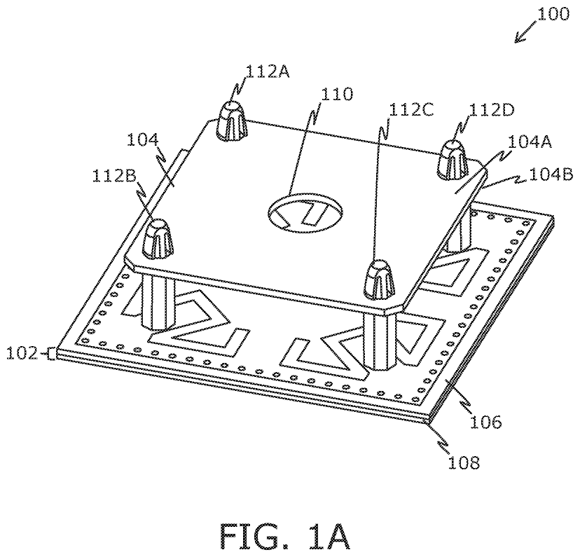

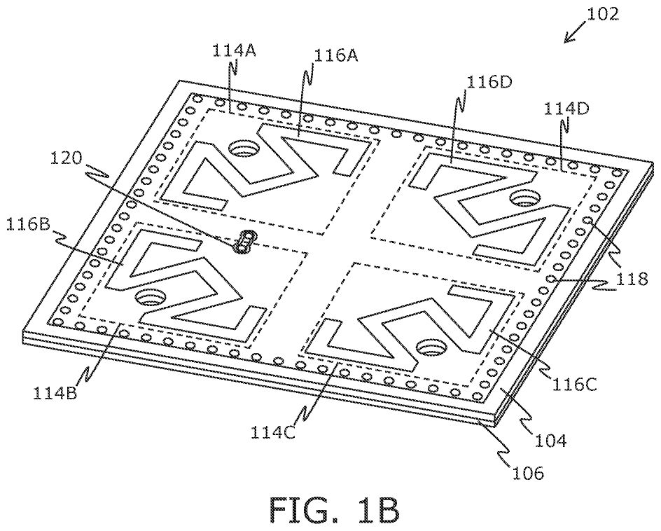

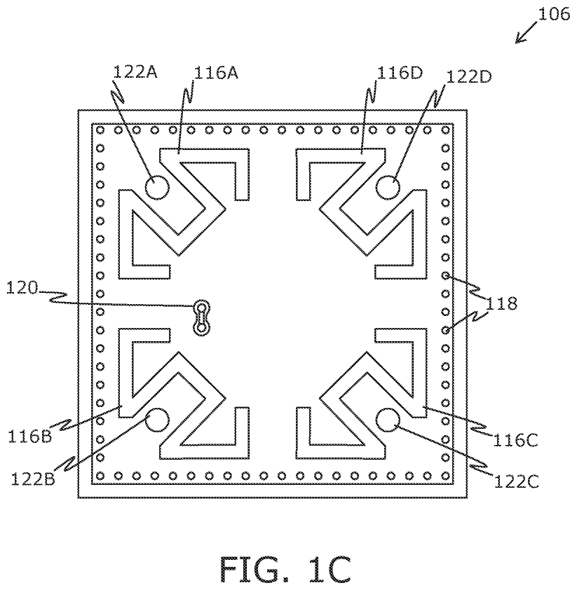

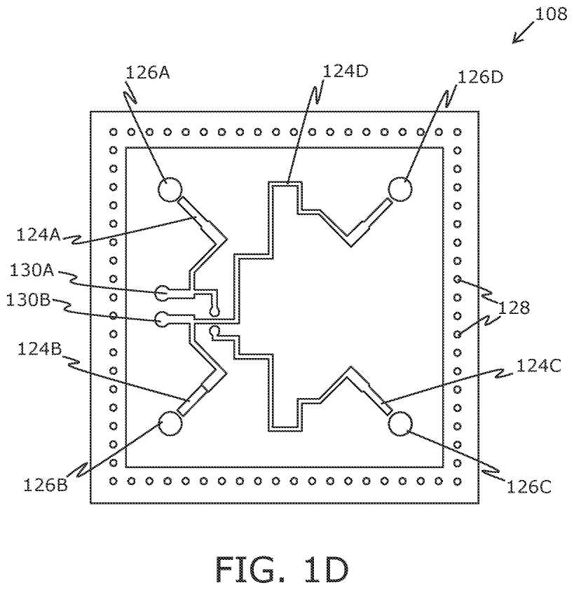

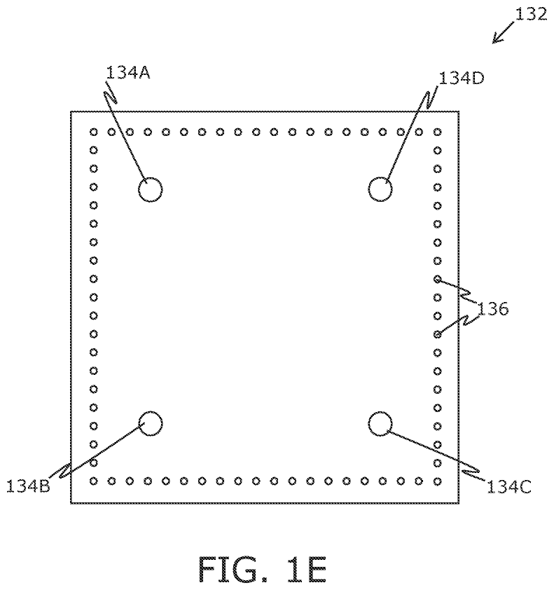

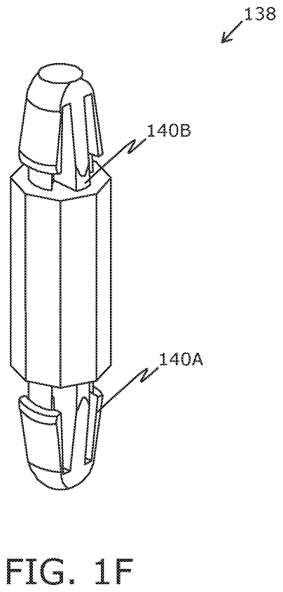

FIG. 1A is an illustration of an antenna device, in accordance with an embodiment of the present disclosure. With reference to FIG. 1A, there is shown an antenna device 100. The antenna device 100 includes a radiator (hereinafter referred to as a first radiator 104), a top layer 106, and a middle layer 108. There is further shown an opening 110 in the first radiator 104 and four standoffs (namely a first standoff 112A, a second standoff 112B, a third standoff 112C, and a four standoff 112D) in the antenna device 100.

The antenna device 100 may also be referred to as a radiating element, a radiating device, or an antenna element of an antenna. The antenna device 100 is used for telecommunication. For example, the antenna device 100 may be used in a wireless communication system. In some embodiments, an array of such antenna devices or one or more antenna devices, may be used in the communication system. Examples of such wireless communication system include, but is not limited to, a base station (such as an Evolved Node B (eNB), a gNB, and the like), a repeater device, a customer premise equipment, and other customized telecommunication hardware.

The top layer 106 is arranged above the middle layer 108. Alternatively stated, the top layer 106 when arranged above the middle layer 108 may be collectively referred to as a feeding arrangement 102. The feeding arrangement 102 may also be referred to as a feeding structure. The top layer 106 and the middle layer 108 is further described in detail, for example, in FIGS. 1B, 1C, and 1D. The antenna device 100 further includes a bottom layer (not shown in FIG. 1A), where the middle layer 108 is arranged above the bottom layer. An exemplary bottom layer is further described, for example, in FIG. 1E. The arrangement of the top layer 106 over the middle layer 108, and further the middle layer 108 over the bottom layer forms a stack structure. In other words, the feeding arrangement 102 has the stack structure that includes the top layer 106, the middle layer 108, and the bottom layer.

Optionally, in some embodiments, in addition to the top layer 106, the middle layer 108, and the bottom layer, one or more other layers are potentially provided in the antenna device 100. In accordance with an embodiment, the feeding arrangement 102 is configured to feed current to the first radiator 104. Moreover, the feeding arrangement 102 (i.e. the top layer 106, the middle layer 108, and the bottom layer collectively) has a planar structure and is configured to provide a structural support to the first radiator 104.

In accordance with an embodiment, each of the feeding arrangement 102 (i.e. the top layer 106, the middle layer 108, and the bottom layer collectively) and the first radiator 104 has a quadrilateral shape (i.e. a polygon with four edges or sides). In an implementation, the feeding arrangement 102 (i.e. the top layer 106, the middle layer 108, and the bottom layer collectively) has a square shape, where each side of the square has a size of about 53 mm (i.e. both length and width of 53 mm). In another implementation, each side of the square has a size in a range of 45-61 mm. In such implementation, the size is typically from 45, 47, 49, 51, 53, 55, 57, or 59 mm up to 47, 49, 51, 53, 55, 57, 59, or 61 mm. In an implementation, the first radiator 104 further has an approximately square shape, where each side of the square has a size of about 40 mm (i.e. both length and width of 40 mm). In another implementation, each side of the square of the first radiator 104 has a size in a range of 35-45 mm. In such implementation, the size of each side is typically from 35, 37, 39, 41, or 43 mm up to 37, 39, 41, 43, or 45 mm. In another implementation, each of the feeding arrangement 102 (i.e. the top layer 106, the middle layer 108, and the bottom layer) and the first radiator 104 has a rectangular or a polygonal shape. In the FIG. 1A, as shown, the size of the first radiator 104 is smaller than the top layer 106 (or the feeding arrangement 102). However, it is to be understood by one of ordinary skill in the art that the size of the first radiator 104 may be as big as or bigger than one of the layers of the feeding arrangement 102.

The first radiator 104 is arranged above the top layer 106 at a distance from the top layer 106. In an implementation, the distance is potentially in a range of 5-15 mm. In such implementation, the distance is typically from 5, 7, 9, 11, or 13 mm up to 7, 9, 11, 13, or 15 mm. In another implementation, the distance is 10 millimetres (mm).

In accordance with an embodiment, the antenna device 100 comprises four standoffs arranged between the first radiator 104 and the top layer 106, where the four standoffs are electrically non-conductive. Each of the four standoffs (i.e. the first standoff 112A, the second standoff 112B, the third standoff 112C, and the four standoff 112D) refers to a support structure that holds the first radiator 104 above the top layer 106. Specifically, each of the first standoff 112A, the second standoff 112B, the third standoff 112C, and the four standoff 112D enables the first radiator 104 to be placed at the distance from the top layer 106. Each of the first standoff 112A, the second standoff 112B, the third standoff 112C, and the four standoff 112D has an elongated structure. Each of the first standoff 112A, the second standoff 112B, the third standoff 112C, and the four standoff 112D has a first end and a second end. The first end is coupled to the feeding arrangement 102, whereas the second end of each of the four standoffs is coupled to the first radiator 104. In an embodiment, the standoffs are made of plastic, and are electrically non-conductive.

In accordance with an embodiment, the first radiator 104 has a planar structure with a plurality of perforations (e.g. four perforations) provided at different peripheral areas (e.g. corner positions) of the first radiator 104 to receive the four standoffs, such as the first standoff 112A, the second standoff 112B, the third standoff 112C, and the four standoff 112D. Each of the plurality of perforations (e.g. the four perforations) of the first radiator 104 is configured to receive the second end of each of the four standoffs. In an example, the four perforations of the first radiator 104 are complementary in shape and size to four perforations of the feeding arrangement 102. Each of the plurality of perforations of the first radiator 104 is arranged in such a way that each perforation of the first radiator 104 is aligned (almost in a straight line) with each perforation of the feeding arrangement 102 to receive the four standoffs. The first end of each of the four standoffs is inserted in one of the four perforations of the top layer 106, the middle layer 108 and the bottom layer (i.e. the feeding arrangement 102). The second end of each of the four standoffs 112A, 112B, 112C and 112D is inserted in each of the corresponding four perforations of the first radiator 104.

In accordance with an embodiment, the first radiator 104 is configured to radiate a first electromagnetic signal in a first frequency band. The first electromagnetic signal is radiated when the antenna device 100 is in operation and when current is received from the feeding arrangement 102. The receipt of current from the feeding arrangement 102 and a source of current is further described, for example, in FIG. 1C.

In accordance with an embodiment, the first radiator 104 is a patch radiator. The patch radiator refers to a flat radiating patch that is configured to radiate the first electromagnetic signal in the first frequency band. The first radiator 104 in the form of the patch radiator has a top surface 104A and a bottom surface 104B. The first electromagnetic signal in the first frequency band is radiated from the top surface 104A, whereas the bottom surface 104B is arranged to face the top layer 106 of the feeding arrangement 102. In an implementation, the first radiator 104 is a metallic patch radiator.

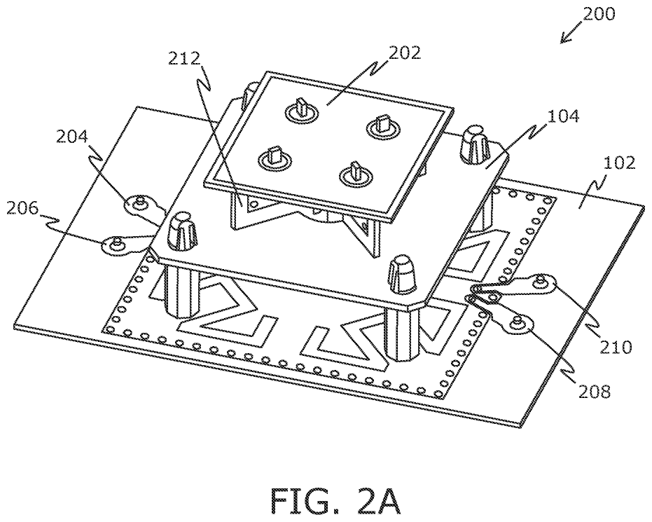

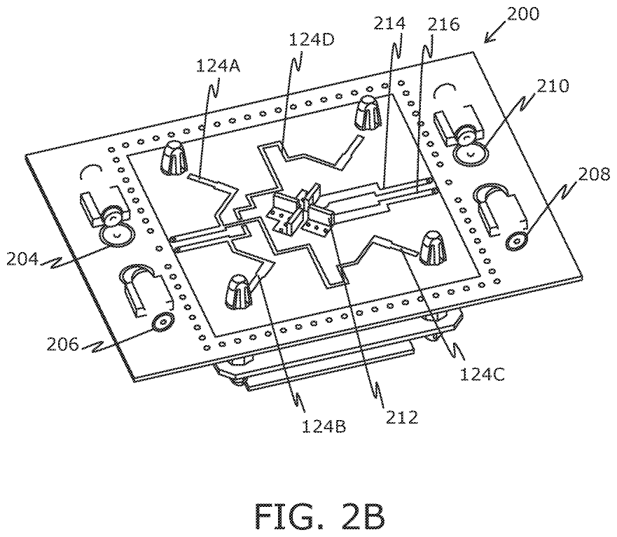

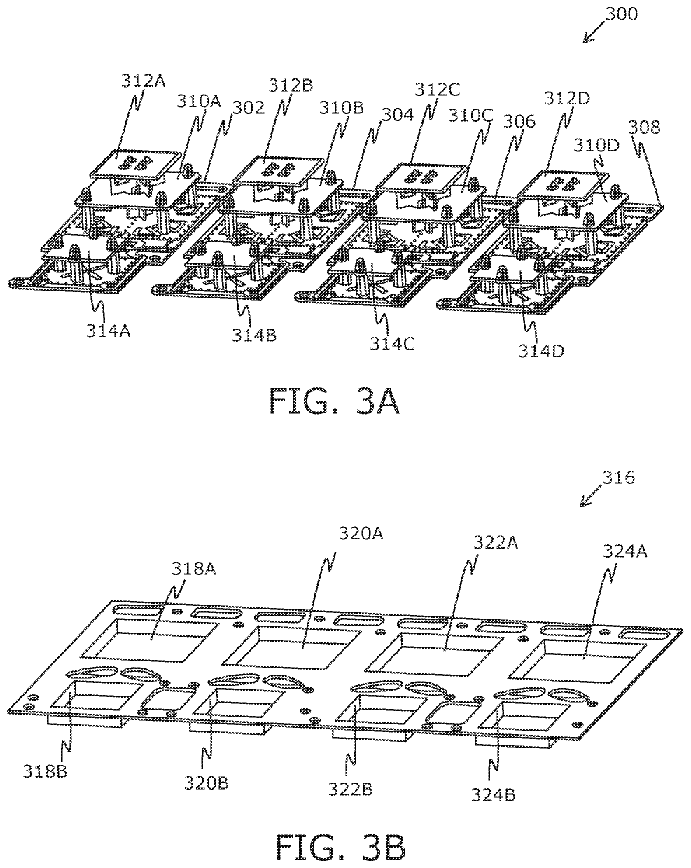

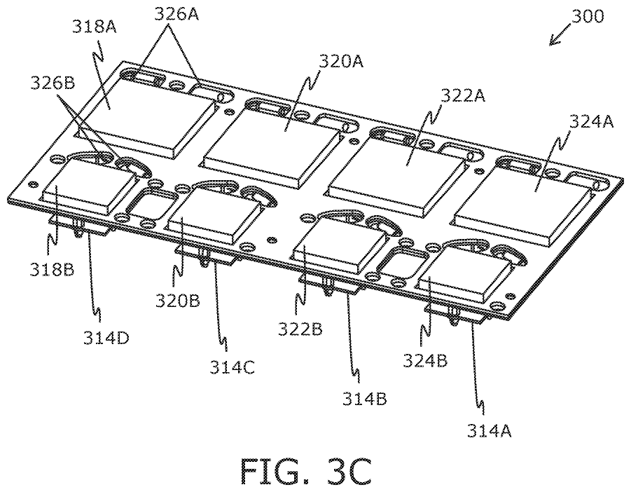

In some embodiments, the antenna device 100 includes more than one radiator, such as two radiators (described, for example, in FIG. 2A) or three radiators (described, for example, in FIG. 3A) to form a dual-band or a multi-band antenna device. In such embodiments, electromagnetic signals are radiated concurrently by different radiators in different frequency bands (e.g. a high frequency band and a low frequency band). In an example, the first radiator 104 is a low band radiator, where the first frequency band corresponds to a low frequency band as compared to a frequency band (e.g. a comparatively high frequency band) in which another radiator (when provided) operates.

In accordance with an embodiment, the first radiator 104 has a planar structure with the opening 110 at a substantially central position of the first radiator 104. The opening 110 may also be referred to as a cut-out. In this embodiment, the opening 110 is circular, or approximately circular in shape. However, it is to be understood by one of ordinary skill in the art that the shape of the opening 110 may vary without limiting the scope of the disclosure. For example, the opening 110 may be oval, rectangular, square, or polygonal in shape. The opening 110 at the substantially central position of the first radiator 104 simplifies the arrangement of an additional radiator (e.g. a second radiator) above the first radiator 104, thereby increasing the compactness of the antenna device 100 without any degradation of performance of the antenna device 100. Moreover, a central area of the top layer 106 is free of any features (e.g. slots) and the opening 110 lies above the central area. Thus, the opening 110 enables to provide support as well as feed current to the additional radiator (e.g. the second radiator) without increasing any parts in the antenna device 100 and without causing any signal interference when the first radiator 104 and the additional radiator (e.g. the second radiator) are in operation.

FIG. 1B is an illustration of a top layer arranged above a middle layer in an antenna device, in accordance with an embodiment of the present disclosure. FIG. 1B is described in conjunction with elements from FIG. 1A. With reference to FIG. 1B, there is shown the top layer 106 arranged above the middle layer 108. The top layer 106 arranged above the middle layer 108 in the form of a stack structure is collectively referred to as the feeding arrangement 102.

In accordance with an embodiment, the antenna device 100 further comprises a multilayer printed circuit board, where the top layer 106, the middle layer 108 and the bottom layer are layers of the multilayer printed circuit board. In other words, the top layer 106, the middle layer 108, and the bottom layer are implemented as one of the layers of the multilayer printed circuit board.

In accordance with another embodiment, the antenna device 100 further comprises a dual layer printed circuit board, where a first layer of the dual layer printed circuit board is the top layer 106 and a second layer of the dual layer printed circuit board is the middle layer 108 and the bottom layer is implemented in a separate part capacitively or galvanically coupled to the middle layer 108. The dual layer printed circuit board has conductive tracks (e.g. a metal-based, such as copper-based conductive tracks) arranged on at least one layer, such as the second layer of the dual layer printed circuit board. Moreover, the conductive tracks enable flow of electric current in the feeding arrangement 102.

In accordance with an embodiment, the feeding arrangement 102 has a stack structure that includes has a first region 114A, a second region 114B, a third region 114C and a fourth region 114D. The first region 114A is opposite to the third region 114C, and the second region 114B is opposite to the fourth region 114D. The stack structure comprises a bottom layer (FIG. 1E), the middle layer 108, and the top layer 106. The middle layer 108 is arranged between the bottom layer and the top layer 106.

The top layer 106 has a first slot 116A, a second slot 116B, a third slot 116C, and a fourth slot 116D. In a case where the top layer 106 is a square, the first slot 116A, the second slot 116B, the third slot 116C, and the fourth slot 116D are located within four quadrants of the square. For example, if the square is equally divided into four imaginary quadrants, each of four slots is located in one quadrant of the four quadrants. Specifically, each of four slots are located in the four corner areas of the square. In an example, specifically, the first slot 116A, the second slot 116B, the third slot 116C, and the fourth slot 116D are located at the first region 114A, the second region 114B, the third region 114C, and the fourth region 114D, respectively. Each of the first slot 116A, the second slot 116B, the third slot 116C, and the fourth slot 116D formed in the top layer 106 is configured to provide current to the first radiator 104. In a conventional antenna device, either a continuous slot is provided, or two or more slots are provided that cross the center area of a conventional feeding arrangement, which increases complexity. Beneficially, in contradiction to the conventional antenna device, four slots are provided at peripheral areas (or corner areas), for example, at the first region 114A, the second region 114B, the third region 114C, and the fourth region 114D, as shown in an example. As a result of the arrangement of the four slots at peripheral areas (i.e. corner areas), the present disclosure does not require use of any additional structures as used in conventional antenna devices to overcome intersection between feeding lines and slots. Furthermore, the central area of the top layer 106 is free of any features, such as any slots, connections, and the like), which further simplifies the antenna design of the antenna device 100.

In accordance with an embodiment, each of the slots has a meandering shape. The meandering shape of the slots (i.e. the first slot 116A, the second slot 116B, the third slot 116C, and the fourth slot 116D) enables a compact arrangement of the slots formed in the top layer 106. The compact arrangement of the slots as a result of the meandering shape significantly contributes to reduce the overall size of the antenna device 100. Optionally, each of the slots have a symmetrical shape.

In accordance with an embodiment, each of the four slots (i.e. the first slot 116A, the second slot 116B, the third slot 116C, and the fourth slot 116D) are formed at a defined location and angle with respect to each other. Optionally, each of the slots are at approximately same distance from corresponding adjacent slots. Beneficially, the arrangement of several slots in different corner areas to keep the central area vacant (i.e. free of any features or additional parts) can avoid interference between electromagnetic signals of different frequency bands (such as a lower frequency band and a higher frequency band) radiated by the first radiator 104 and a second radiator (when present) in an antenna device (e.g. the antenna device 100).

FIG. 1C is an illustration of an exemplary top layer in an antenna device, in accordance with an embodiment of the present disclosure. FIG. 1C is described in conjunction with elements from FIGS. 1A and 1B. With reference to FIG. 1C, there is shown the top layer 106. The top layer 106 further includes vias 118, a line crossing 120, and a plurality of perforations, such as a first perforation 122A, a second perforation 122B, a third perforation 122C, and a fourth perforation 122D, as shown in an example. There is further shown the first slot 116A, the second slot 116B, the third slot 116C, and the fourth slot 116D formed in the top layer 106. In an example, the first slot 116A may be located within the first region 114A, the second slot 116B may be located within the second region 114B, the third slot 116C may be located within the third region 114C, and the fourth slot 116D may be located within the fourth region 114D. As an example implementation the first slot 116A, the second slot 116B, the third slot 116c and the fourth slot 116D are arranged as areas within the surface (as seen from above in the figure) which do not have conductive material. In practical implementation the top layer 106 is PCB board which is covered with copper in other areas than in slots. Slots in other words form an opening to a conductive layer (which is normally grounded).

In accordance with an embodiment, the top layer 106 has a planar structure, where the vias 118 are arranged on the edges of the top layer 106. The vias are holes (small openings) in the top layer 106. The vias 118 enables to establish a physical connection between the top layer 106, the middle layer 108 (and the bottom layer). The line crossing 120 enables an electrical connection between a first feeding line and a third feeding line of the middle layer 108 over a fourth feeding line of the middle layer 108. The different feeding lines and their connections is shown and described in detail, for example, in FIG. 1D.

In accordance with an embodiment, the plurality of perforations (i.e. the first perforation 122A, the second perforation 122B, the third perforation 122C, and the fourth perforation 122D) are arranged within the first region 114A, the second region 114B, the third region 114C, and the fourth region 114D, as shown in an example. Specifically, each of the plurality of perforations is arranged at a mouth of each of the four slots (e.g. at the mouth of a U-shaped bending of each slot, facing corners of the top layer 106), as shown in an example. The plurality of perforations is configured to receive one end (i.e. a first end) of the four standoffs (FIG. 1A). Examples of the shape of the plurality of perforations include, but is not limited to, a circular, an oval, a rectangular, and a polygonal shape. In an example, each of the plurality of perforations is located at a diagonal position from of each corner of the top layer 106, as shown. Optionally, the four perforations are located at an approximately same distance from each other.

FIG. 1D is an illustration of an exemplary middle layer in an antenna device, in accordance with an embodiment of the present disclosure. FIG. 1D is described in conjunction with elements from FIGS. 1A, 1B, and 1C. With reference to FIG. 1D, there is shown the middle layer 108. There is further shown a first feeding line 124A, a second feeding line 124B, a third feeding line 124C, a fourth feeding line 124D, a plurality of perforations (namely a first perforation 126A, a second perforation 126B, a third perforation 126C, and a fourth perforation 126D), vias 128, a first feeding node 130A and a second feeding node 130B in the middle layer 108. In an example embodiment the feeding lines are conductive material such as copper lines. The middle layer 108 is coupled to the top layer 106 (FIG. 1C). Moreover, the middle layer 108 is arranged above the bottom layer (FIG. 1E) and below the top layer 106. The middle layer 108 has the first feeding line 124A, the second feeding line 124B, the third feeding line 124C, and the fourth feeding line 124D. Moreover, the first feeding line 124A and the third feeding line 124C are electrically connected to the first feeding node 130A, and the second feeding line 124B and the fourth feeding line 124D are electrically connected to the second feeding node 130B. Each feeding line is a conductive track (e.g. a metal wiring or track) laid on the middle layer 108 for current distribution in the feeding arrangement 102. The first feeding line 124A is electrically connected to the third feeding line 124C via the line crossing 120 in the top layer 106 (FIG. 1C). Moreover, the first feeding node 130A and the second feeding node 130B are feeding node terminals that act as a current source for the first radiator 104 (FIG. 1A). Specifically, the first feeding node 130A and the second feeding node 130B provide electric current to the four feeding lines of the middle layer 108 of the feeding arrangement 102 for the current distribution. Moreover, the first feeding node 130A and the second feeding node 130B provide electric current to enable the first radiator 104 to radiate the first electromagnetic signal in the first frequency band. In a signal receiving mode, the first feeding node 130A and the second feeding node 130B may act as output instead of input. In an example, the first feeding node 130A and the second feeding node 130B may be connected to an external power source.

Moreover, a portion of the first slot 116A, a portion of the second slot 116B, a portion of the third slot 116C and a portion of the fourth slot 116D (FIGS. 1B and 1C) overlap with a portion of the first feeding line 124A, a portion of the second feeding line 124B, the portion of a third feeding line 124C, and the portion of the fourth feeding line 124D, respectively. In other words, the first feeding line 124A, the second feeding line 124B, the third feeding line 124C, and the fourth feeding line 124D (at the middle layer 108) beneath the top layer 106 crosses (or pass over the center of) the first slot 116A, the second slot 116B, the third slot 116C and the fourth slot 116D, respectively (in the stack structure of the feeding arrangement 102). the overlap of the four slots with the corresponding four feeding lines enable a flow of feed current from the middle layer 108 to the top layer 106.

In accordance with an embodiment, each feeding line on middle layer 108 overlaps corresponding slot on the top layer 106 at least once. In other words, each of the four feeding lines cross the four slots. In the conventional antenna devices (or antenna), additional components, such as coaxial cables or probes, are required to provide feed current or to connect the conventional feeding lines to conventional slots due to their high structural complexity. For example, in the conventional antenna devices, if there is a breakage or a fault in the additional components, the performance of the antenna is affected, and the maintenance cost is increased. In contradiction to the conventional antenna devices (or antenna), in the present disclosure, due to the overlaps, each of four feeding lines are directly connected (i.e. electrically conductive) to the corresponding slot without the use of any additional parts, such as cables or probes. As a result, the present disclosure provides an antenna device (e.g. the antenna device 100) with a particularly simple design.

In accordance with an embodiment, the middle layer 108 is potentially implemented as a separate part capacitively or galvanically coupled to the top layer 106. The middle layer 108 (similar to the top layer 106) is implemented on a printed circuit board. In an example, the middle layer 108 may be implemented as a single layer printed circuit board, or as one of the layers of a multi-layer printed circuit board. The middle layer 108 may also be referred to as a second conductive plate of the feeding arrangement 102.

In accordance with an embodiment, the middle layer 108 has a planar structure with four perforations arranged at the first region 114A, the second region 114B, the third region 114C, and the fourth region 114D (FIG. 1B) to receive the four standoffs. In an example, the four perforations of the middle layer 108 are similar in shape, size and structure (i.e. complementary structures) to the four perforations of the top layer 106. In other words, the position of the plurality of perforations of the top layer 106 and the plurality of perforations of the middle layer 108 are arranged in a way that each perforation of the top layer 106 is aligned with each perforation of the middle layer 108 to form a passage to receive the four standoffs.

In accordance with an embodiment, the middle layer 108 further includes the vias 128 similar to that of the vias 118 of the top layer 106.The vias 128 are arranged on the edges of the middle layer 108. The vias 128 enables to establish a physical connection between the top layer 106 and the bottom layer.

In accordance with an alternative embodiment, instead of having one middle layer (i.e. the middle layer 108), the feeding arrangement 102 potentially includes a plurality of middle layers (including the middle layer 108). In such an embodiment, the plurality of middle layers is implemented as a unitary part (i.e. connected as single unit or part). In other words, the middle layer 108 is connected to one or more additional layers to form the plurality of middle layers. Beneficially, the plurality of middle layers increases thickness of the middle layer 108 and thereby enables in providing physical strength and rigidity to the middle layer 108. Further, the plurality of middle layers also enables in providing strength to support to the first radiator 104 without increasing any complexity.

FIG. 1E is an illustration of an exemplary bottom layer in an antenna device, in accordance with an embodiment of the present disclosure. FIG. 1E is described in conjunction with elements from FIGS. 1A to 1D. With reference to FIG. 1E, there is shown a bottom layer 132. The antenna device 100 (FIG. 1A) further comprises the bottom layer 132. Alternatively stated, the bottom layer 132 may be a part of the stack structure of a feeding arrangement (e.g. the feeding arrangement 102 of FIG. 1A). Similar to that of the top layer 106 and the middle layer 108, the bottom layer 132 also includes a plurality of perforations (such as a first perforation 134A, a second perforation 134B, a third perforation 134C and a fourth perforation 134D), and vias 136.

The bottom layer 132 is arranged as a cavity-backed ground. The cavity-backed ground refers to metallic cavities integrated in the back (e.g. non-radiating side) of an antenna device (e.g. the antenna device 100). Typically, in an example, in order to increase the operating bandwidth of a patch radiator, a thick substrate is used in the back side of a conventional antenna device. The thick substrate causes the propagation of surface waves which reduces the radiation efficiency. In contradiction to conventional devices, in order to minimize surface wave excitation and its associated losses, a cavity-backed ground may be used in the antenna device 100. In the cavity backed approach, patch radiators, such as the first radiator 104, has an integration of metal cavities in the back side to suppress the surface waves. An example of the cavity-backed ground is further described, for example, in FIG. 3B and 3C. The bottom layer 132 is configured to act as a ground to the feed current distributed by the feeding lines of the middle layer 108. Moreover, the bottom layer 132 (like the top layer 106 and the middle layer 108) is implemented on a printed circuit board. In an example, the middle layer 108 may be implemented as a single layer printed circuit board, or as one of the layers of a multi-layer printed circuit board. The bottom layer may also be referred to as a third conductive plate of the feeding arrangement 102.

In accordance with an embodiment, the bottom layer 132 also has a planar structure with four perforations. In an example, the four perforations are arranged at the first region 114A, the second region 114B, the third region 114C, and the fourth region 114D (FIG. 1B) to receive the four standoffs. In an example, the four perforations of the bottom layer 132 are similar in shape, size and structure (i.e. complementary structures) to the four perforations of the top layer 106 and the middle layer 108. In other words, a position of the plurality of perforations of the bottom layer 132 is located such that each perforation of the top layer 106 and the middle layer 108 is aligned with each corresponding perforation of the bottom layer 132 to form a passage to receive the four standoffs. Moreover, the vias 136 of the bottom layer 132 are similar and complementary in shape and position to that of the vias 118 of the top layer 106 and the vias 128 of the middle layer 108.

FIG. 1F is an exemplary illustration of a standoff of an antenna device, in accordance with an embodiment of the present disclosure. FIG. 1F is described in conjunction with elements from FIGS. 1A to 1E. With reference to FIG. 1F, there is shown a standoff 138. In an example, the standoff 138 is a plastic standoff. In another example, the standoff 138 is potentially made of other non-conductive polymeric material, known in the art. The standoff 138 has a first end 140A and a second end 140B. The first end 140A is inserted in one of the four perforations of the feeding arrangement 102 (i.e. each of the top layer 106, the middle layer 108 and the bottom layer 132). The second end 136B of the standoff 138 is inserted in the corresponding perforation of the first radiator 104. The standoff 138 is electrically non-conductive. In an example, the standoff 138 is an elongated structure with a mid-section that is polygonal in shape with the two ends having a conical shape. However, it is to be understood by one of ordinary skill in the art that the shape of the standoff 138 may vary. For example, the standoff 138 may be oval, rectangular, square, or polygonal in shape.

FIG. 2A is a perspective top view of an antenna device, in accordance with another embodiment of the present disclosure. FIG. 2A is described in conjunction with elements from FIG. 1A to 1F. With reference to FIG. 2A, there is shown an antenna device 200. The antenna device 200 includes a second radiator 202 in addition to the first radiator 104. The antenna device 200 includes a first feeding node 204 and a second feeding node 206. There is further shown a third feeding node 208, a fourth feeding node 210, a support structure 212, and the feeding arrangement 102. In an example, the feeding arrangement 102 is implemented as dual layer printed circuit board, where the top layer 106 is implemented as a first layer of the dual layer printed circuit board and the middle layer 108 is implemented as a second layer of the dual layer printed circuit board. The bottom layer is implemented as a separate part as a cavity-backed ground. In another example, the feeding arrangement 102 is implemented as a multilayer printed circuit board, where each of the top layer 106, the middle layer 108, and the bottom layer corresponds to one layer of the multilayer printed circuit board.

In accordance with an embodiment, the first radiator 104 is configured to radiate a first electromagnetic signal in a first frequency band, whereas the second radiator 202 is configured to radiate a second electromagnetic signal in the second frequency band. In an example, the first frequency band is different from the second frequency band. Thus, the antenna device 200 is a dual band antenna device (i.e. a dual band antenna element) that is configured to radiate electromagnetic signals in two frequency bands concurrently. For example, any two frequency bands, such as from 700 MHz, 800 MHz, 900 MHz, 1.8 GHz, 2.1 GHz, 2.6 GHz, or 3.5 GHz, may be radiated concurrently. In another example, the first radiator 104 and the second radiator 202 may radiate electromagnetic signals in two frequency bands concurrently that are below 6 GHz (i.e. sub-6 GHz frequency bands), or two different frequency bands in operating range of mmWave frequencies, or a combination thereof.

In an example, an operating range of the second frequency band is higher than the first frequency band. In this example, the first radiator 104 operates in a low frequency band and the second radiator 202 operates in high frequency band. In another example, the second radiator 202 radiates the second electromagnetic signal having lower frequency compared to first electromagnetic signal radiated by the first radiator 104. In an implementation, the second radiator 202 is a high-band patch radiator. Other examples of the second radiator 202 include, but is not limited to a patch radiator, a dipole radiator, a type of high-band radiator, or other radiators.

In accordance with an embodiment, the second radiator 202 has a quadrilateral shape (i.e. a polygon with four edges (or sides). In an implementation, the second radiator 202 has an approximately square shape, where each side of the square has a size of about 28 mm (i.e. both length and width of 28 mm). In another implementation, each side of the square has a size in a range of 20-40 mm, typically from 20, 25, 30, or 35 mm up to 25, 30, 35, or 40 mm. In another implementation, the second radiator 202 has a rectangular or a polygonal shape. In this case, as shown, the size of the the second radiator 202 is smaller than the first radiator 104. However, it is to be understood by one of ordinary skill in the art that the size of the second radiator 202 may vary. For example, the size of the the second radiator 202 may be same or less than the size of first radiator 104.

In accordance with an embodiment, the second radiator 202 is arranged above the first radiator 104 at a second distance from the top layer 106. The second distance is selected such that there is no interference between the first electromagnetic signal of the first frequency band and the second electromagnetic signal of the second frequency band. In an example, the second distance is equal to the first distance. In another example, the second distance is less than the first distance. In an implementation, the second distance is in a range of 5-20 mm. In an example, the second distance is typically from 5, 7, 9, 11, 13, 15, 17, or 19 mm up to 7, 9, 11, 13, 15, 17, 19, or 20 mm.

In accordance with an embodiment, the first radiator 104 comprises the opening 110 (FIG. 1A). The second radiator 202 lies above the opening 110. In accordance with an embodiment, the antenna device 200 further comprises the support structure 212 (e.g. a holder or spacer) having a first end and a second end. The first end of the support structure 212 is coupled to the second radiator 202, and the second end of the support structure 212 is coupled to the feeding arrangement 102 through the opening 110 of the first radiator 104. In this embodiment, the support structure 212 provides support and holds the second radiator 202 on the feeding arrangement 102 and over the first radiator 104. Optionally, the support structure 212 is made of metallized plastic.

The first feeding node 204 is configured to provide feed current to the first feeding line 124A and the third feeding line 124C of the feeding arrangement 102. The second feeding node 206 is configured to provide feed current to the second feeding line and the fourth feeding line of the feeding arrangement 102. The third feeding node 208 and the fourth feeding node 210 are configured to provide feed current to two feeding lines that feed current to the second radiator 202. Optionally, the second radiator 202 is electrically coupled with the two feeding lines that receives current from the third feeding node 208 and the fourth feeding node 210. The second radiator 202 is configured to radiate the second electromagnetic signal based on the current provided by the two feeding lines (show and further described, for example, in FIG. 2B). The first feeding node 204 and the second feeding node 206 corresponds to the first feeding node 130A and the second feeding node 130B respectively of FIG. 1D. In an example, the first feeding node 204 and the second feeding node 206 collectively may be a low band feeding node (or feeding node terminals) meant for the first radiator 104, whereas the third feeding node 208 and the fourth feeding node 210 collectively may be a high band feeding node (or feeding node terminals) meant for the second radiator 202.

FIG. 2B is a perspective bottom view of the antenna device of FIG. 2A, in accordance with another embodiment of the present disclosure. FIG. 2B is described in conjunction with elements from FIGS. 1A to 1F, and 2A. With reference to FIG. 2B, there is shown a bottom view of the antenna device 200. In the FIG. 2B, there is shown four feeding lines, such as the first feeding line 124A, the second feeding line 124B, the third feeding line 124C, the fourth feeding line 124D. The four feeding lines are configured to feed current to the first radiator 104 and may be also referred to as a first set of feeding lines. There is further shown additional two feeding lines, such as a fifth feeding line 214 and a sixth feeding line 216. The two feeding lines are configured to feed current to the second radiator 202 and may also be referred to as a second set of feeding lines. The antenna device 200 includes the first feeding node 204 and the second feeding node 206.

In accordance with an embodiment, the antenna device 200 further includes the third feeding node 208, the fourth feeding node 210, and the support structure 212. The first feeding node 204 and the second feeding node 206 corresponds to the first feeding node 130A and the second feeding node 130B of FIG. 1C, respectively. The two feeding lines, such as the fifth feeding line 214 and the sixth feeding line 216, are provided in the middle layer 108, and are electrically connected to the third feeding node 208 and the fourth feeding node 210. Beneficially, the feeding lines laid on the middle layer 108 are simple in design in comparison to conventional technologies and no additional structures are required to prevent undesirable intersection of the four feeding lines for the first radiator 104 and the additional two feeding lines (i.e. the fifth feeding line 214 and the sixth feeding line 216) for the second radiator 202.

FIG. 3A is a perspective top view an array of antenna devices, in accordance with an embodiment of the present disclosure. FIG. 3A is described in conjunction with elements from FIGS. 1A to 1F, 2A, and 2B. With reference to FIG. 3A, there is shown an array 300 of antenna devices. The array 300 comprises one or more antenna structures, such as the antenna device 100 (FIG. 1A) or the antenna device 200 (FIG. 2A).

In accordance with an embodiment, the array 300 includes a plurality of antenna devices, such as a first antenna device 302, a second antenna device 304, a third antenna device 306 and a fourth antenna device 308, which are arranged in an array (i.e. one after other). Optionally, in an implementation, each of the first antenna device 302, the second antenna device 304, the third antenna device 306 and the fourth antenna device 308 comprises three radiators arranged on a same printed circuit board. By virtue of having three radiators arranged on the same printed circuit board, the complexity (i.e. the structural as well as the manufacturing complexity) and size of the array 300 of one or more antenna devices is significantly reduced. Moreover, such compact arrangement of three radiators on the same printed circuit board does not degrade the performance of any antenna device and provides a capability to each antenna device to concurrently support increased number of frequency bands, thereby also increasing the number of users that can be supported. In an example, the first antenna device 302 includes a first radiator 310A, a second radiator 312A, and a third radiator 314A. The first radiator 310A and the second radiator 312A corresponds to the first radiator 104 and the second radiator 202 respectively (FIG. 2A). The first radiator 310A and the second radiator 312A are configured to operate in a first frequency band and a second frequency band respectively, where the first frequency band is different from the second frequency band. The third radiator 314A is configured to operate in at least one of: the first frequency band, the second frequency band, or a third frequency band that is different from the first frequency band and the second frequency band. Similarly, the second antenna device 304 includes three radiators, such as a first radiator 310B, a second radiator 312B, and a third radiator 314B. The third antenna device 306 includes three radiators, such as first radiator 310C, a second radiator 312C, and a third radiator 314C. The fourth antenna device 308 includes a first radiator 310D, a second radiator 312D, and a third radiator 314D. The first antenna device 302, the second antenna device 304, the third antenna device 306 and the fourth antenna device 308 are electrically connected to form the array 300.

In this embodiment, instead of using a multilayer printed circuit board to feed current to a radiator (e.g. the first radiator 310A, 310B, 310C, and 310D), a standard, double-sided printed circuit board is used in the array 300, where a cavity back ground (described, for example, in FIG. 3B) is implemented as an additional part of the array 300. The multilayer printed circuit board generally associated with high productions costs, is thus not required, thereby reducing manufacturing cost of components and the overall cost of the array 300 of antenna devices. The double-sided printed circuit board may further include filtering section and power dividers to distribute power to different radiators.

FIG. 3B is a top view of a cavity-backed ground implemented as a separate part, in accordance with an embodiment of the present disclosure. FIG. 3B is described in conjunction with elements from FIGS. 1A to 1F, 2A, 2B, and 3A. With reference to FIG. 3B, there is shown a top view of a layer 316 having cavities 318A, 318B, 320A, 320B, 322A, 322B, 324A, and 324B. The layer 316 is implemented as a separate part of the array 300 of antenna devices. The layer 316 may be formed of bended metal sheet, metallized plastic, or any other suitable structure or process to function as a reflector and the cavity backed ground for the double-sided printed circuit board used in the array 300. In an implementation, the layer 316 may correspond to a bottom layer implemented as a separate part. A thickness (i.e. a depth) of a cavity (e.g. the cavities 318A, 318B, 320A, 320B, 322A, 322B, 324A, and 324B) influences bandwidth of a radiator (e.g. a radiator of the array 300 of antenna devices). Beneficially, a thickness (i.e. a depth) of the cavity can be increased, as per use case, and therefore bandwidth of a radiator, may also be increased or adjusted accordingly.

In this exemplary implementation, several cavities (e.g. the cavities 318A, 318B, 320A, 320B, 322A, 322B, 324A, and 324B) are implemented together in one part. In this exemplary implementation, the layer 316 (e.g. a metallic sheet) has 8 cavities (e.g. in a 2×4 arrangement) implement in one part. In other words, in the 2×4 arrangement, there are two rows, where a first row has four cavities 318A, 320A, 322A, and 324A for four radiators and a second row has another four cavities 318B, 320B, 322B, and 324B for other four radiators. In the first row, the four cavities 318A, 320A, 322A, and 324A are larger, where dual-band radiators are arranged above the four cavities 318A, 320A, 322A, and 324A, whereas in the second row, the radiators arranged above the four cavities 318B, 320B, 322B, and 324B are a single band radiator (e.g. the third radiators). It is to be understood by a person of ordinary skill in the art that the disclosure is not limited to any specific combination of frequency bands. For example, one, two or more than two frequency bands may coexist together, having one or more radiators working on higher or lower frequency bands interleaved between the dual-band radiators, as shown in FIG. 3A, in an example.

FIG. 3C is a bottom view of the cavity-backed ground of FIG. 3B integrated with an array of antenna devices, in accordance with an embodiment of the present disclosure. FIG. 3C is described in conjunction with elements from FIGS. 1A to 1F, 2A, 2B, 3A, and 3B. With reference to FIG. 3C, there is shown a bottom view of the layer 316 that depicts the bottom view of the cavities 318A, 318B, 320A, 320B, 322A, 322B, 324A, and 324B. There is further shown a third radiator (i.e. the third radiators 314A, 314B, 314C, and 314D) of each antenna device of the array 300 of antenna devices integrated with the layer 316. The layer 316 further includes openings (or cut outs) to allow electrical connections (from power source) to feeding nodes of the radiators of the array 300 of antenna devices. For example, openings 326A may be provided to connect to feeding nodes for the first radiators (e.g. low band radiators), and openings 326B may be provided to connect to feeding nodes of second and/or third radiators (e.g. high band radiators).

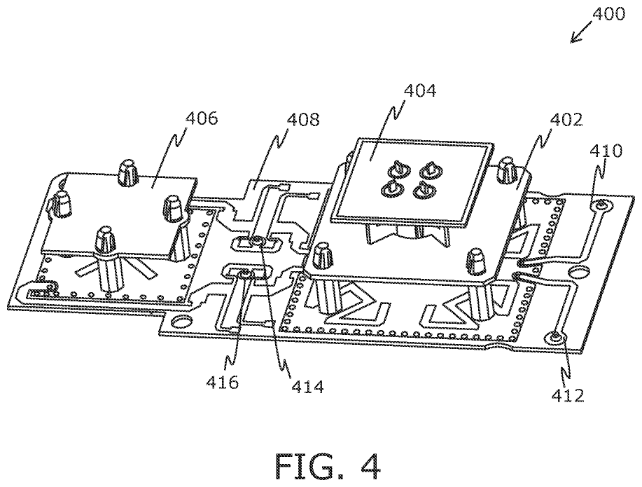

FIG. 4 is a perspective top view of an antenna device, in accordance with another embodiment of the present disclosure. FIG. 4 is described in conjunction with elements from FIGS. 1A to 1F, 2A, 2B, and 3A to 3C. With reference to FIG. 4, there is shown the antenna device 400. The antenna device 400 includes a first radiator 402, a second radiator 404 and a third radiator 406 implemented on a printed circuit board 408. The antenna device 400 further includes a first feeding node 410, a second feeding node 412, a third feeding node 414 and a fourth feeding node 416.

The first radiator 402 is configured to radiate a first electromagnetic signal in a first frequency band. The second radiator 404 is configured to radiate a second electromagnetic signal in a second frequency band. The third radiator 406 is configured to radiate a third electromagnetic signal in a third frequency band. In an example, the second frequency band and the third frequency band may be higher than the first frequency band (low band). The first radiator 402, the second radiator 404, and the third radiator 406 corresponds to the first radiator 104 or 310A (FIG. 1A, 2A, or 3A), the second radiator 202 or 312A (FIG. 2A or 3A), and the third radiator 314A (FIG. 3A), respectively.

The first feeding node 410 and the second feeding node 412 are configured to feed current to the first radiator 402. In an example, the first feeding node 410 and the second feeding node 412 are low band feeding nodes to feed low band patch radiator, such as the first radiator 402. The third feeding node 414 and the fourth feeding node 416 are configured to provide feed current to other two radiators, such as the second radiator 404 and the third radiator 406. Beneficially, all the three radiators are implemented on a same printed circuit board 408, which reduces the complexity of the antenna device 400. The antenna device 400 further includes a power divider, for example, to divide power supply for the second radiator 404 and the third radiator 406 (e.g. two high band radiators) and a filtering section in the same printed circuit board 408, which is used to feed the first radiator 402 (e.g. a low band radiator).

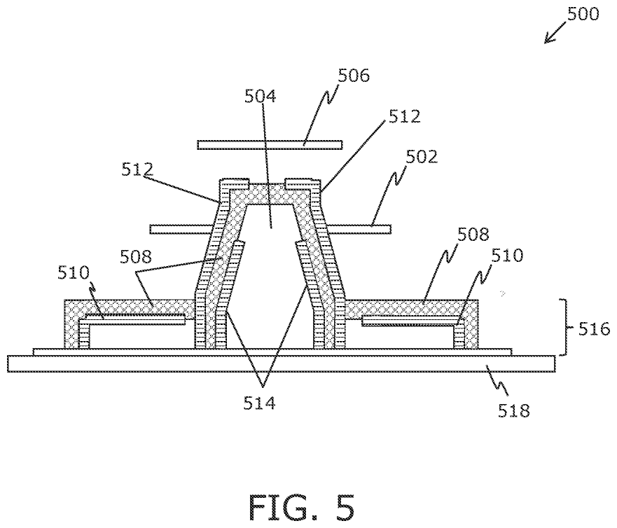

FIG. 5 is a cross-sectional view of an antenna device, in accordance with an embodiment of the present disclosure. FIG. 5 is described in conjunction with elements from FIGS. 1A to 1F, 2A, 2B, 3A to 3C, and 4. With reference to FIG. 5, there is shown a cross-section of an antenna device 500. The antenna device 500 includes a first radiator 502 having a planar structure with an opening 504 at a substantially central position of the first radiator 502. The antenna device 500 further includes a second radiator 506 that lies above the opening 504 of the first radiator 502. The antenna device 500 has a plastic body 508 with metallisation 510.

In accordance with an embodiment, the antenna device 500 may include probes 512 (metallic conductors) that feed current to the second radiator 506 and probes 514 that are connected to the cavity-backed ground. Unlike the conventional devices, the probes 512 and 514 are not used to support radiators. In this case, in an example, the four slots formed in a top layer of a feeding arrangement 516 as well as the probes 512 and 514 used to feed the second radiator 506 may be implemented in one metallized plastic body (e.g. the plastic body 508 with the metallisation 510). A middle layer (e.g. of the feeding arrangement 516) may include feeding lines to feed current to the first radiator 502 and the second radiator 506. The antenna device 500 includes a reflector 518 that may include metallic cavities in the back side of the antenna device 500 to suppress the surface radiation waves from the antenna device 500 to minimize losses and improve radiation efficiency. In an example, the reflector 518 may correspond to the layer 316 of FIGS. 3B and 3C. In an example, the metallized plastic body (e.g. the plastic body 508 with the metallisation 510 may also include support structures (e.g. holders or standoffs) to support the patch radiators (e.g. the first radiator 502 and the second radiator 506). The metallized plastic body may be soldered to a printed circuit board, for example, using a surface-mount technology (SMT) known in the art, or using perforations. The use of the metallized plastic body enables arrangement of multiple radiators, and further contributes in reducing the complexity of the antenna device 500.

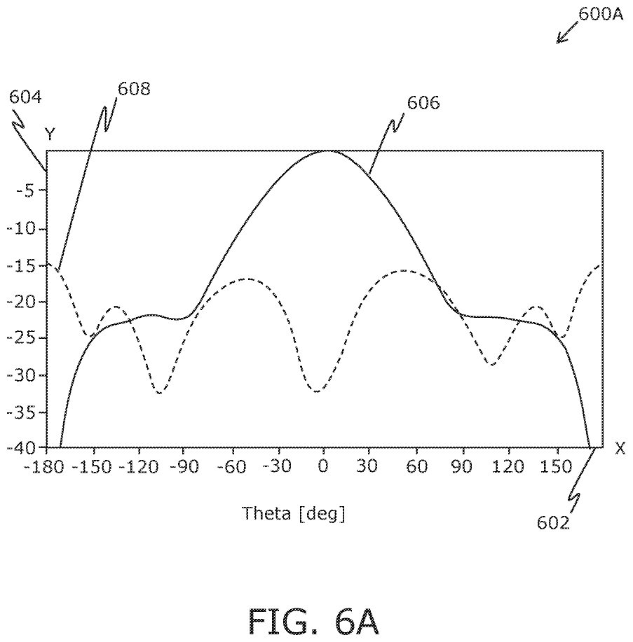

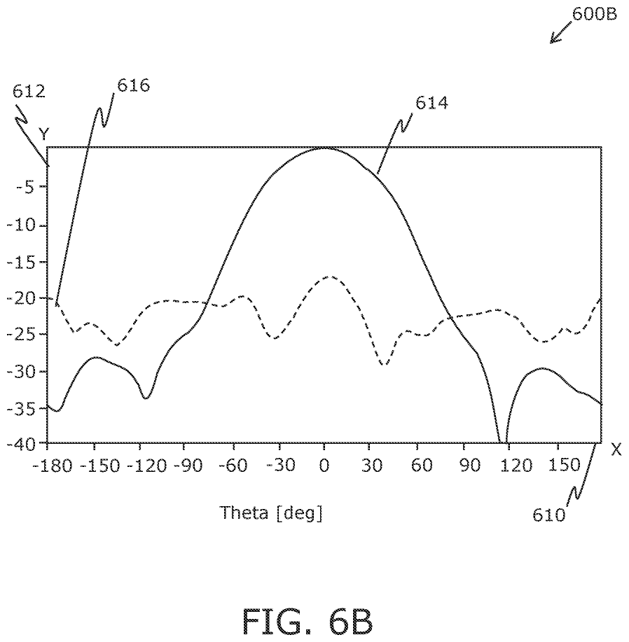

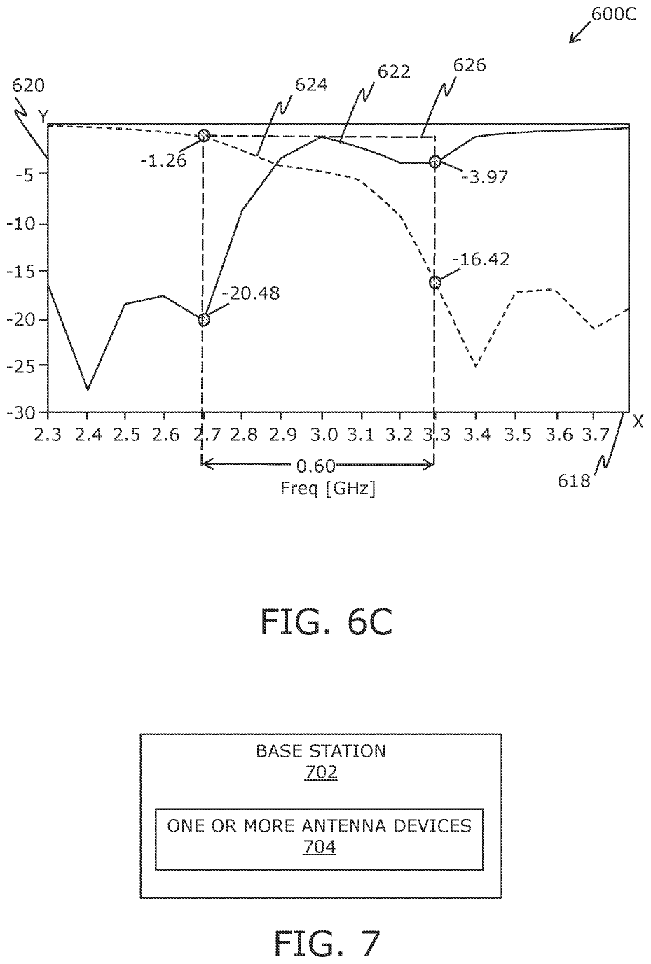

FIG. 6A is a graphical representation that depicts a radiation pattern of an electromagnetic signal radiated by a first radiator in a first frequency band, in accordance with an embodiment of the present disclosure. FIG. 6A is described in conjunction with elements from FIGS. 1A to 1F, 2A, 2B, 3A to 3C, 4, and 5. With reference to FIG. 6A, there is shown a graphical representation 600A of a radiation pattern in terms of a co-polarization (Copol) pattern and a cross-polarization (Xpol) pattern of a first electromagnetic signal in the first frequency band.

The graphical representation 600A represents theta (in degrees) on X-axis 602 and values of cross-polarization and co-polarization on Y-axis 604. A co-polarization curve 606 of the first radiator 104 is represented by solid lines. A cross-polarization curve 608 of the first radiator 104 is represented by dotted lines. The co-polarization curve 606 indicates radiation of the first first electromagnetic signal in the first frequency band from the first radiator 104 in a desired polarization, whereas cross-polarization curve 608 indicates radiation in the orthogonal polarization, which is less than the co-polarization.

FIG. 6B is a graphical representation that depicts a radiation pattern of an electromagnetic signal radiated by a second radiator in a second frequency band, in accordance with an embodiment of the present disclosure. FIG. 6B is described in conjunction with elements from FIGS. 1A to 1F, 2A, 2B, 3A to 3C, 4, 5, and 6A. With reference to FIG. 6B, there is shown a graphical representation 600B of a radiation pattern in terms of a co-polarization (Copol) and a cross-polarization (Xpol) of a second electromagnetic signal radiated in the second frequency band.

The graphical representation 600B represents theta (in degrees) on X-axis 610 and values of cross-polarization and co-polarization on Y-axis 612. A co-polarization curve 614 as a result of radiation from the second radiator 202 is represented by solid lines. A cross-polarization curve 616 is represented by dotted lines. The co-polarization curve 614 indicates radiation of the second first electromagnetic signal in the second frequency band from the second radiator 202 in a desired polarization, whereas the cross-polarization curve 616 indicates radiation in the orthogonal, which is less than the co-polarization.

FIG. 6C is a graphical representation that depicts the return loss of a dual-band radiator, in accordance with an embodiment of the present disclosure. FIG. 6C is described in conjunction with elements from FIGS. 1A to 1F, 2A, 2B, 3A to 3C, 4, 5, 6A, and 6B. With reference to FIG. 6C, there is shown a graphical representation 600C in terms of return loss measured for the first electromagnetic signal (FIG. 6A) in the first frequency band and the second electromagnetic signal (FIG. 6B) in the second frequency band.

The graphical representation 600C represents frequency in Gigahertz (GHz) in X-axis 618 with respect to values of return losses on Y-axis 620. A first curve 622 (represented by solid lines) indicates return loss for the first electromagnetic signal radiated by the first radiator 104 in the first frequency band. A second curve 624 (represented by dotted lines) indicates return loss for the second electromagnetic signal radiated by the second radiator 202 in the second frequency band. In the graphical representation 600C, the values of return loss (indicates by thick dots) in a dotted box 626 depicts that first frequency band and second frequency band can co-exist in the antenna device 200 without interference of their electromagnetic signals with each other, and thereby the antenna device (e.g. the antenna device 200, 300, or 400 having two or more radiators) has a stable performance.

FIG. 7 is a block diagram that illustrates a base station with one or more antenna devices, in accordance with an embodiment of the present disclosure. FIG. 7 is described in conjunction with elements from FIGS. 1A to 1F, 2A, 2B, 3A to 3C, 4, 5, and 6A to 6C. With reference to FIG. 7, there is shown a base station 702 that comprises one or more antenna devices 704, such as the antenna device 100, 200, 300, 400, or 500.

The base station 702 include suitable logic, circuitry, and/or interfaces that may be configured to communicate with a plurality of wireless communication devices over a cellular network (e.g. 2G, 3G, 4G, or 5G) via the one or more antenna devices 704, such as the antenna device 100, 200, 300, 400, or 500. Examples of the base station 702 may include, but is not limited to, an evolved Node B (eNB), a Next Generation Node B (gNB), and the like. In an example, the base station 702 may include an array of antenna devices (e.g. the array 300 of antenna devices) that function as an antenna system to communicate with the plurality of wireless communication devices in an uplink and a downlink communication. Examples of the plurality of wireless communication devices include, but is not limited to, a user equipment (e.g. a smartphone), a customer premise equipment, a repeater device, a fixed wireless access node, or other communication devices or telecommunications hardware.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. An antenna device (100, 200, 400, 500), comprising:
a first feeding node (130A, 204, 410) and a second feeding node (130B, 206, 412);
a bottom layer (132) arranged as a cavity-backed ground;
a middle layer (108) arranged above the bottom layer (132), the middle layer (108) comprising a first feeding line (124A), a second feeding line (124B), a third feeding line (124C) and a fourth feeding line (124D), wherein the first feeding line (124A) and the third feeding line (124C), are electrically connected to the first feeding node (130A, 204, 410), and the second feeding line (124B) and the fourth feeding line (124D) are electrically connected to the second feeding node (130B, 206, 412); and
a top layer (106) arranged above the middle layer (108), the top layer (106) having a first slot (116A), a second slot (116B), a third slot (116C) and a fourth slot (116D) formed in the top layer (106), wherein a portion of the first slot (116A), a portion of the second slot (116B), a portion of the third slot (116C) and a portion of the fourth slot (116D) overlap with a portion of the first feeding line (124A), a portion of the second feeding line (124B), a portion of the third feeding line (124C) and a portion of the fourth feeding line (124D), respectively; and
a radiator arranged above the top layer (106) at a distance from the top layer (106).

2. The antenna device (100, 200, 400, 500) according to claim 1, wherein said radiator is a first radiator (104, 402, 502) and said distance is a first distance and wherein the antenna device (100, 200, 400, 500) further comprises a second radiator (202, 404, 506) arranged above the first radiator (104, 402, 502) at a second distance from the top layer (106).

3. The antenna device (100, 200, 400, 500) according to claim 2, wherein the first radiator (104, 402, 502) is configured to radiate a first electromagnetic signal in a first frequency band and the second radiator (202, 404, 506) is configured to radiate a second electromagnetic signal in a second frequency band.

4. The antenna device (100, 200, 400, 500) according to claim 2, wherein the first radiator (104, 402, 502) is a patch radiator.

5. The antenna device (100, 200, 400, 500) according to claim 2, wherein the first radiator (104, 402, 502) has a planar structure with an opening (110, 504) at a substantially central position of the first radiator (104, 402, 502), and wherein the second radiator (202, 404, 506) lies above the opening (110, 504).

6. The antenna device (100, 200, 400, 500) according to claim 1, comprising a multilayer printed circuit board, wherein the top layer (106), the middle layer (108) and the bottom layer (132) are layers of the multilayer printed circuit board.

7. The antenna device (100, 200, 400, 500) according to claim 1, comprising a dual layer printed circuit board, wherein a first layer of the dual layer printed circuit board is the top layer (106) and a second layer of the dual layer printed circuit board is the middle layer (108) and the bottom layer (132) is implemented in a separate part capacitively or galvanically coupled plate to the middle layer (108).

8. The antenna device (100, 200, 400, 500) according to claim 1, wherein each of the slots has a meandering shape.

9. The antenna device (100, 200, 400, 500) according to claim 1, comprising four standoffs arranged between the first radiator (104, 402, 502) and the top layer (106), wherein the four standoffs that are electrically non-conductive.

10. An array (300) of antenna devices, the array comprising one or more antenna devices, wherein each antenna device of the one or more antenna devices comprises:
a first feeding node and a second feeding node;
a bottom layer arranged as a cavity-backed ground;
a middle layer arranged above the bottom layer, the middle layer comprising a first feeding line, a second feeding line, a third feeding line and a fourth feeding line, wherein the first feeding line and the third feeding line are electrically connected to the first feeding node, and the second feeding line and the fourth feeding line are electrically connected to the second feeding node;
a top layer arranged above the middle layer, the top layer having a first slot, a second slot, a third slot and a fourth slot formed in the top layer, wherein a portion of the first slot, a portion of the second slot, a portion of the third slot, and a portion of the fourth slot overlap with a portion of the first feeding line, a portion of the second feeding line, a portion of the third feeding line, and a portion of the fourth feeding line, respectively; and
a radiator arranged above the top layer at a distance from the top layer.

11. A base station comprising one or more antenna devices, wherein each antenna device of the one or more antenna devices comprises:
a first feeding node and a second feeding node;
a bottom layer arranged as a cavity-backed ground;
a middle layer arranged above the bottom layer, the middle layer comprising a first feeding line, a second feeding line, a third feeding line and a fourth feeding line, wherein the first feeding line and the third feeding line are electrically connected to the first feeding node, and the second feeding line and the fourth feeding line are electrically connected to the second feeding node; and
a top layer arranged above the middle layer, the top layer having a first slot, a second slot, a third slot and a fourth slot formed in the top layer, wherein a portion of the first slot, a portion of the second slot, a portion of the third slot, and a portion of the fourth slot overlap with a portion of the first feeding line, a portion of the second feeding line, a portion of the third feeding line, and a portion of the fourth feeding line, respectively; and
a radiator arranged above the top layer at a distance from the top layer.
